(19) United States
(12) Patent Application Publication
(10) Pub. No.: US 2026/0138195 A1
(43) Pub. Date: May 21, 2026

(54) HYDRAULIC EXPANSION CHUCK FOR RECEIVING A TOOL

(71) Applicant: Gühring KG, Albstadt (DE)

(72) Inventor: Christian STEIDLE, Albstadt (DE)

(73) Assignee: Gühring KG, Albstadt (DE)

(21) Appl. No.: 19/119,746

(22) PCT Filed: Oct. 12, 2023
(86) PCT No.: PCT/EP2023/078279

§ 371 Date: Apr. 9, 2025

(30) Foreign Application Priority Data
Oct. 14, 2022 (DE) 10 2022 126 854.3

(51) Int. Cl. B23B 31/30

(52) U.S. Cl. CPC B23B 31/305

(57) ABSTRACT

A hydraulic expansion chuck (1) for receiving a cutting tool, having a chuck main body (2, 3) with a connection part (3) for fastening to a machine tool and having a clamping part (2) for clamping the cutting tool in a center receiving opening (4), wherein the clamping tool (2) comprises at the receiving opening (4) at least one first expansion chamber (5) and radially spaced therefrom a second expansion chamber (6).

The invention relates to a hydraulic expansion chuck for receiving a cutting tool.

The use of hydraulic expansion chucks is widespread. Conventional hydraulic expansion chucks are constructed in one piece and have a section with internal chambers for clamping a tool, as well as a section for the machine-side connection.

To clamp the tool, a fluid is introduced into chambers, which fill and expand accordingly when a pressure is applied to the fluid. Due to the expansion of these chambers, the tool introduced into the hydraulic expansion chuck is clamped. Hydraulic expansion chucks clamp a tool when an expansion chamber bulges in the direction of the inserted tool, whereby a clamping force is exerted.

In the prior art, a hydraulic expansion chuck for receiving and clamping cutting tools is described, for example, in the DE 10 2015 120 971 A1. This hydraulic expansion chuck comprises a chuck main body with a separate clamping bush, on the front end of which the shank of a cutting tool is clamped. Axially spaced apart chambers, into which a fluid is introduced under pressure in order to bulge the chambers outwards, are arranged within the wall of the front part.

It is a disadvantage of these known hydraulic expansion chucks that the optimal clamping of a shank of a cutting tool is not always ensured, the height of the generated clamping forces is limited in particular due to the type of the expansion chambers.

It is the object of the present invention to provide a hydraulic expansion chuck, which overcomes the disadvantages from the prior art and which is suitable to optimally clamp the shank of a cutting tool.

The invention comprises a hydraulic expansion chuck for receiving a cutting tool with a chuck main body with a connection part for fastening to a machine tool and with a clamping part for clamping the cutting tool in a central receiving opening. At the receiving opening, the clamping part comprises at least one first expansion chamber and radially spaced apart therefrom a second expansion chamber. It has been shown that the occurring clamping forces can be increased due to the two expansion chambers lying at a radial distance from one another, so that the cutting tool can be clamped in an optimally fixed manner.

According to an advantageous aspect, the first expansion chamber comprises at least two separate sub-chambers, which lie at the same radial distance from the central axis of the hydraulic expansion chuck. The at least two separate sub-chambers preferably lie symmetrically on a common circle around the central axis of the hydraulic expansion chuck.

The first expansion chamber particularly preferably comprises exactly three separate sub-chambers. The three sub-chambers can each be interrupted, in each case by means of a recess, which lies therebetween and which is open towards the center.

The three sub-chambers advantageously have an identical size and geometry. The sub-chambers are arranged on a common circle in a rotationally symmetrical manner (triple symmetry).

The second expansion chamber is advantageously formed in a ring-shaped The second expansion chamber can be formed as continuous full circle (full cylinder), which encloses the sub-chambers of the first expansion chamber.

The second expansion chamber advantageously comprises two chamber rings, which are connected to a connecting channel in the axial direction.

The first expansion chamber and the second expansion chamber are advantageously fluidically connected to one another via a chamber channel. The pressure on the fluid can thus be increased in both expansion chamber via a common unit.

Each Sub-chamber of the first expansion chamber and the second expansion chamber is preferably connected (to one another) via a separate chamber channel.

An advantageous aspect provides that each sub-chamber of the first expansion chamber and the second expansion chamber are connected via three separate chamber channels. A homogenous pressure distribution is ensured therewith.

The hydraulic expansion chuck particularly preferably further comprises an actuating unit for applying pressure to a fluid, wherein the actuating unit is connected to the first expansion chamber via a connecting channel. A hollow space (bore with thread) filled with fluid, into which a screw can be screwed in order to decrease the volume for the fluid located in the hollow space, in that the screw is actuated, represents a simple solution.

The receiving opening advantageously comprises three slot openings, which are each spaced apart at an angle of 120°. A sub-chamber is thereby in each case arranged between two slot openings.

The invention will be explained in more detail below on the basis of the examples illustrated in the enclosed drawings. Identical reference numerals relate to the same features in all figures, in which:

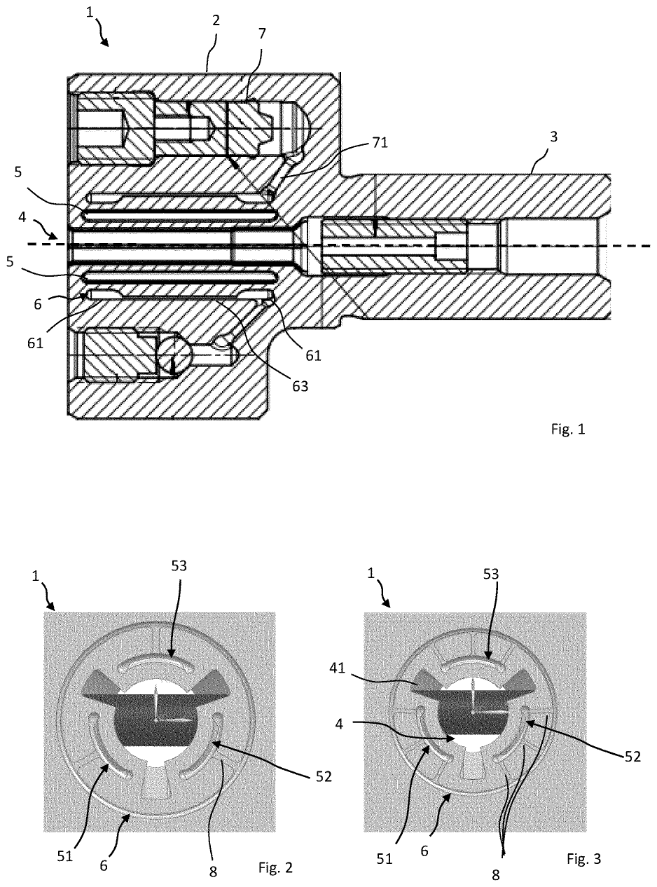

FIG. 1 shows a sectional view from the side of the hydraulic expansion chuck for receiving a cutting tool according to an exemplary embodiment of the invention;

FIG. 2 shows a partial sectional view of a first variation with three sub-chambers of the first expansion chamber of the hydraulic expansion chuck from FIG. 1; and

FIG. 3 shows a partial sectional view of a second variation with three sub-chambers of the first expansion chamber of the hydraulic expansion chuck from FIG. 1.

FIG. 1 shows a lateral sectional view from the side of the hydraulic expansion chuck 1 for receiving a cutting tool (not illustrated) according to an exemplary embodiment of the invention.

The hydraulic expansion chuck 1 has a chuck main body 2, 3 with a connection part 3 for fastening to a machine tool (not illustrated) and with a clamping part 2 for clamping the (shank of a) cutting tool (not illustrated) in a central receiving opening 4. At the receiving opening 4, the clamping part 2 comprises at least one first expansion chamber 5 and radially spaced apart (externally) therefrom a second expansion chamber 6.

The second expansion chamber 6 is formed so as to completely enclose the first expansion chamber 5 on the outside in a ring-shaped manner.

The second expansion chamber 6 comprises two chamber rings 61, which are connected to a connecting channel 63 in the axial direction. The chamber rings have a cross section, which is enlarged compared to the connecting channel.

The hydraulic expansion chuck 1 comprises an actuating unit 7 for applying a fluid (hydraulic oil) filled into the expansion chambers. In the shown example, the actuating unit 7 is connected to the first expansion chamber 5 via a connecting channel 71.

A partial sectional view of a first variation of the hydraulic expansion chuck 1 from FIG. 1 is illustrated in FIG. 2, with three sub-chambers of the first expansion chamber 5.

In the shown example, the first expansion chamber 5 has exactly three separate sub-chambers 51, 52, 53. The separate sub-chambers 51, 52, 53 lie at the same radial distance from the central axis of the hydraulic expansion chuck 1. In this example, the three sub-chambers 51, 52, 53 have an identical size and geometry.

The first expansion chamber 5 and the second expansion chamber 6 are fluidically connected to one another via a chamber channel 8. Each sub-chamber 51, 52, 53 is connected to the second expansion chamber 6 via a single separate chamber channel 8.

The second expansion chamber 6 is formed in a ring-shaped manner, as can be seen well in this view, in contrast to FIG. 1.

A partial sectional view of f a second variation of the hydraulic expansion chuck 1 from FIG. 1 is illustrated in FIG. 3.

In this example, the first expansion chamber 5 comprises three sub-chambers 51, 52, 53 again.

Each sub-chamber 51, 52, 53 of the first expansion chamber 5 is connected to the second expansion chamber 6 via three separate chamber channels 8.

The receiving opening 4 comprises three slot openings 41, which are each spaced apart at an angle of 120° and which are open towards the center.

A sub-chamber 51, 52, 53 is thereby in each case between two slot openings 41.

1. A hydraulic expansion chuck for receiving a cutting tool with a chuck main body with a connection part for fastening to a machine tool and with a clamping part for clamping the cutting tool in a central receiving opening, wherein at the receiving opening, the clamping part comprises at least one first expansion chamber and radially spaced apart therefrom a second expansion chamber.

2. The hydraulic expansion chuck according to claim 1, wherein the first expansion chamber comprises at least two separate sub-chambers, which lie at the same radial distance from the central axis of the hydraulic expansion chuck.

3. The hydraulic expansion chuck according to claim 2, wherein the first expansion chamber comprises exactly three separate sub-chambers.

4. The hydraulic expansion chuck according to claim 3, wherein the three sub-chambers have an identical size and geometry.

5. The hydraulic expansion chuck according to claim 1, wherein the second expansion chamber is formed in a ring-shaped manner.

6. The hydraulic expansion chuck according to claim 4, wherein the second expansion chamber comprises two chamber rings, which are connected to a connecting channel, in the axial direction.

7. The hydraulic expansion chuck ccording to claim 1, wherein the first expansion chamber and the second expansion chamber are fluidically connected to one another via a chamber channel.

8. The hydraulic expansion chuck according to claim 2, wherein each sub-chamber and the second expansion chamber are connected via a separate chamber channel.

9. The hydraulic expansion chuck according to claim 2, wherein each sub-chamber of the first expansion chamber and the second expansion chamber are connected via three separate chamber channels.

10. The hydraulic expansion chuck according to claim 1, further comprising an actuating unit for applying pressure to a fluid, wherein the actuating unit is connected to the first expansion chamber via a connecting channel

11. The hydraulic expansion chuck according to claim 1, wherein the receiving opening comprises three slot openings, which are each spaced apart at an angle of 120°.

12. The hydraulic expansion chuck according to claim 2, wherein a sub-chamber is in each case arranged between two slot openings

13. The hydraulic expansion chuck according to claim 6, wherein each sub-chamber and the second expansion chamber are connected via a separate chamber channel.

14. The hydraulic expansion chuck according to claim 6, wherein each sub-chamber of the first expansion chamber and the second expansion chamber are connected via three separate chamber channels.

15. The hydraulic expansion chuck according to claim 11, wherein a sub-chamber is in each case arranged between two slot openings.
